(19) United States
(12) Patent Application Publication
(10) Pub. No.: US 2008/0232706 A1
(43) Pub. Date: Sep. 25, 2008

(54) METHOD AND APPARATUS FOR ENCODING AND DECODING IMAGE USING PIXEL-BASED CONTEXT MODEL

(75) Inventors: Bae-keun Lee, Bucheon-si (KR); Mathew Manu, Suwon-si (KR); Jae-chool Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-city (KR)

(21) Appl. No.: 12/030,250

(22) Filed: Feb. 13, 2008

(30) Foreign Application Priority Data
Mar. 23, 2007 (KR) 10-2007-0028873

(51) Int. Cl. G06K 9/36

(52) U.S. Cl. 382/239

(57) ABSTRACT

A method and apparatus for encoding and decoding an image are provided. The method includes selecting a context model by referring to previously encoded pixels that are adjacent to the current pixel for entropy-encoding a binary value of a pixel value of the current pixel, and entropy-encoding the binary value using the selected context model, thereby performing entropy-coding with high compression efficiency.

### CROSS-REFERENCE TO RELATED PATENT APPLICATION

This application claims priority from Korean Patent Application No. 10-2007-0028873, filed on Mar. 23, 2007, in the Korean Intellectual Property Office, the disclosure of which is incorporated herein in their entirety by reference.

### BACKGROUND OF THE INVENTION

1. Field of the Invention

Methods and apparatuses consistent with the present invention relate to encoding and decoding an image, and more particularly, to encoding and decoding an image by efficiently performing entropy-encoding and -decoding while reducing system complexity.

2. Description of the Related Art

FIG. 1 is a block diagram of a related art image encoder.

Referring to FIG. 1, a motion compensation unit 104 or an intraprediction unit 106 performs interprediction or intraprediction in a unit of a block. A prediction block generated by interprediction or intraprediction is subtracted from an original block, thereby generating a residue. The generated residue is transformed into a frequency domain by a transformation unit 108. To this end, the transformation unit 108 performs discrete cosine transformation (DCT). A quantization unit 110 then quantizes DCT coefficients. The quantized DCT coefficients are entropy-coded by an entropy coding unit 114 in order to be inserted into a bitstream.

An inverse quantization unit 116 performs inverse quantization on the quantized residue. An inverse transformation unit 120 then performs inverse DCT (IDCT) on the inversely quantized residue. The inversely DCTed residue is added to the prediction block, thereby reconstructing the original block.

The reconstructed block is deblocking-filtered by a filter 122 and then is stored in a frame memory 124 in order to be used for interprediction or intraprediction for another block.

However, some blocks are quantized by a quantization unit 112 without undergoing DCT. Such an encoding method is called bypass mode encoding, which is performed when most pixels of a residue have a pixel value of 0 and only some pixels of the residue have pixel values. In this case, if the residue is transformed into a frequency domain, coefficients exist over the entire frequency domain and thus compression efficiency degrades. For this reason, the residue is quantized and the quantized residue is entropy-coded without being transformed. The quantized residue is inversely quantized by an inverse quantization unit 118 and is added to the prediction block, thereby reconstructing the original block.

FIGS. 2A to 2C illustrate a scanning order for a block that is encoded in a bypass mode according to a related art.

Referring to FIG. 2A, only three pixels among a total of 16 pixels of a block have pixel values. Thus, the block is entropy-coded after being quantized without being transformed into a frequency domain according to bypass mode encoding.

In order to perform entropy-coding, a gradient operation is performed on a block illustrated in FIG. 2A, thereby generating a block illustrated in FIG. 2B. A scanning order 210 is determined according to absolute values of pixel values of the block generated by the gradient operation and a scan operation is performed in a determined scanning order 210 as illustrated in FIG. 2C. Entropy-coding is performed on pixel values 3, 1, 0, −1, 0, 0, 0, 0, 0, 0, 0, 0, 0, 0, 0, 0, 0 that are generated by the scan operation.

For entropy-coding, context-based adaptive binary arithmetic coding (CABAC) is performed. In CABAC, compression efficiency can be improved when a probability that a binary signal is generated in a binary value that is a subject of entropy-coding, i.e., a context model, is accurately predicted. In other words, a probability of ‘0’ or ‘1’ in a binary value has to be accurately predicted.

Thus, in related art bypass mode coding, CABAC is performed using different content models according to scanning orders. In other words, since blocks corresponding to a same scanning order are likely to have similar probabilities of having similar binary signals, CABAC is performed using a same context model.

However, when bypass mode coding is performed according to a related art, a gradient operation has to be performed in order to obtain a scanning order, resulting in high system complexity. To solve this problem, a method of scanning a block in a fixed scanning order for encoding has been suggested. For example, line-by-line scanning is performed in order to encode pixel values of a current block.

When a block is scanned in a fixed scanning order, CABAC cannot be performed using different context models according to different scanning orders because there is only one fixed scanning order. In other words, CABAC cannot use temporal/spatial correlation between the current block and another block that has been bypass-mode encoded prior to the current block.

### SUMMARY OF THE INVENTION

The present invention provides a method and apparatus for encoding and decoding an image, in which the compression efficiency of entropy coding can be improved by selecting a context model with reference to previously encoded pixels, and a computer-readable recording medium having recorded thereon a program for executing the method.

According to one aspect of the present invention, there is provided a method of encoding an image. The method includes binarizing a pixel value of a current pixel, thereby generating a binary value, selecting a context model to be used for entropy-coding the binary value by referring to previously encoded pixels that are adjacent to the current pixel, and entropy-coding the binary value using the selected context model.

The pixel value of the current pixel may be a residue of the current pixel, which is generated in a bypass mode.

The selection of the context model may include determining whether or not pixel values of the previously encoded pixels that are adjacent to the current pixel exist and selecting the context model based on the result of the determination.

The adjacent pixels may include at least one of adjacent pixels located to the left of, to the left of and above, above, and to the right of and above the current pixel.

The entropy-coding of the binary value may include performing context-based adaptive binary arithmetic coding (CABAC) on the binary value.

According to another aspect of the present invention, there is provided an apparatus for encoding an image. The apparatus includes a binarization unit binarizing a pixel value of a current pixel, thereby generating a binary value, a selection unit selecting a context model to be used for entropy-coding the binary value by referring to previously encoded pixels that are adjacent to the current pixel, and a coding unit entropy-coding the binary value using the selected context model.

According to another aspect of the present invention, there is provided a method of decoding an image. The method includes selecting a context model to be used for entropy-decoding a binary value of a pixel value of a current pixel by referring to previously decoded pixels that are adjacent to the current pixel, entropy-decoding the binary value using the selected context model, and performing inverse binarization on the entropy-decoded binary value, thereby reconstructing the pixel value of the current pixel.

The selection of the context model may include determining whether or not pixel values of the previously decoded pixels that are adjacent to the current pixel exist and selecting the context model based on the result of the determination.

The entropy-decoding of the binary value may include performing context-based adaptive binary arithmetic decoding (CABAD) on the binary value.

According to another aspect of the present invention, there is provided an apparatus for decoding an image. The apparatus includes a selection unit selecting a context model to be used for entropy-decoding a binary value of a pixel value of a current pixel by referring to previously decoded pixels that are adjacent to the current pixel, a decoding unit entropy-decoding the binary value using the selected context model, and an inverse binarization unit performing inverse binarization on the entropy-decoded binary value, thereby reconstructing the pixel value of the current pixel.

According to another aspect of the present invention, there is provided computer-readable recording medium having recorded thereon a program for executing the method of encoding an image and the method of decoding an image.

### BRIEF DESCRIPTION OF THE DRAWINGS

The above and other aspects of the present invention will become more apparent by describing in detail an exemplary embodiment thereof with reference to the attached drawings, in which:

FIG. 1 is a block diagram of a related art image encoder;

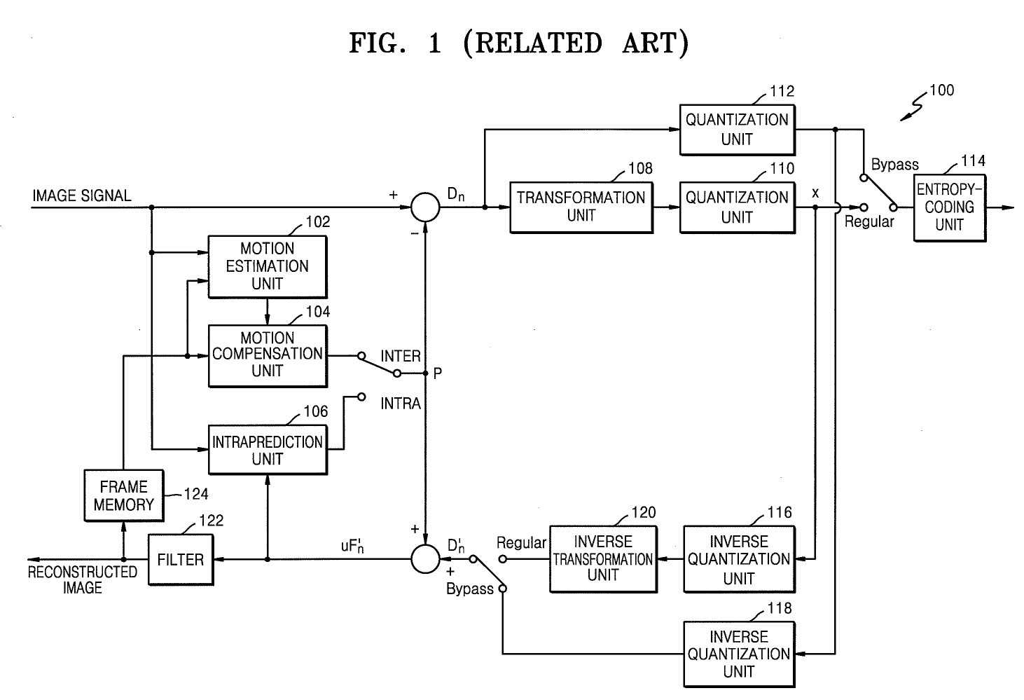

FIGS. 2A to 2C illustrate a scanning order for a block that is coded in a bypass mode according to a related art;

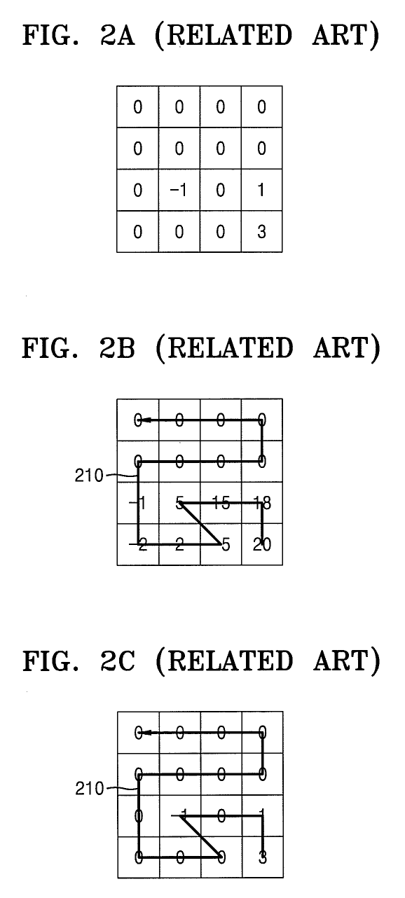

FIG. 3 is a block diagram of an apparatus for encoding an image according to an exemplary embodiment of the present invention;

FIGS. 4A and 4B are views for explaining setting of a context model according to an exemplary embodiment of the present invention;

FIG. 5 is a flowchart of a method of encoding an image according to an exemplary embodiment of the present invention;

FIG. 6 is a block diagram of an apparatus for decoding an image according to an exemplary embodiment of the present invention; and

FIG. 7 is a flowchart of a method of decoding an image according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. It should be noticed that like reference numerals refer to like elements illustrated in one or more of the drawings. In the following description of the exemplary embodiments of the present invention, a detailed description of known functions and configurations incorporated herein will be omitted for conciseness and clarity.

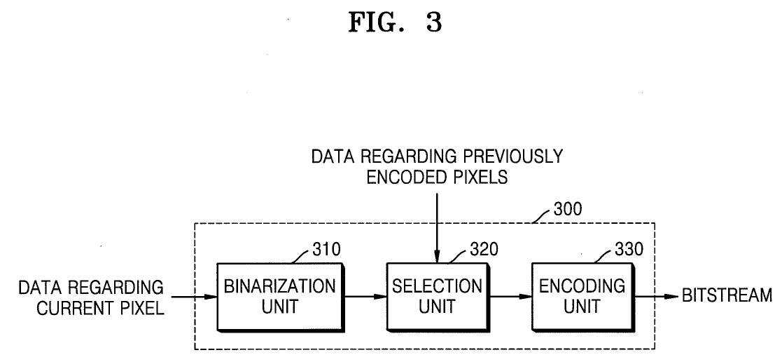

FIG. 3 is a block diagram of an apparatus for encoding an image according to an exemplary embodiment of the present invention.

Referring to FIG. 3, the apparatus includes a binarization unit 310, a selection unit 320, and an encoding unit 330.

The binarization unit 310 receives data regarding a current pixel and performs binarization on the received data, thereby generating a binary value of a pixel value of the current pixel. More specifically, the binarization unit 310 receives a pixel value of a quantized current pixel and binarizes the pixel value into a binary value.

Preferably, but not necessarily, a pixel value received by the binarization unit 310 is a pixel value of the current pixel in a quantized residue generated by bypass mode coding.

The selection unit 320 selects a context model to be used for entropy-coding the current pixel by referring to previously encoded pixels that are adjacent to the current pixel. As mentioned above in relation to the related art, if a scanning order for a bypass-mode coded block varies with a result of a gradient operation with respect to a block, the overall complexity of a coding system increases for the gradient operation. If a fixed scanning order is used to solve this problem, a context model, i.e., temporal/spatial correlation, cannot be used, thereby degrading the compression efficiency of encoding.

Therefore, a context model to be used for entropy-coding is selected for each pixel, and the entropy-coding, i.e., context-based adaptive binary arithmetic coding (CABAC), is performed using the selected context model, thereby performing encoding using temporal/spatial correlation between adjacent pixels irrespective of the order and type of scanning.

To this end, a context model to be used for entropy-coding a pixel value of the current pixel that is binarized by the binarization unit 310 is selected with reference to previously encoded pixels that are adjacent to the current pixel. Preferably, but not necessarily, pixel values of previously encoded pixels are residues for each of the pixels.

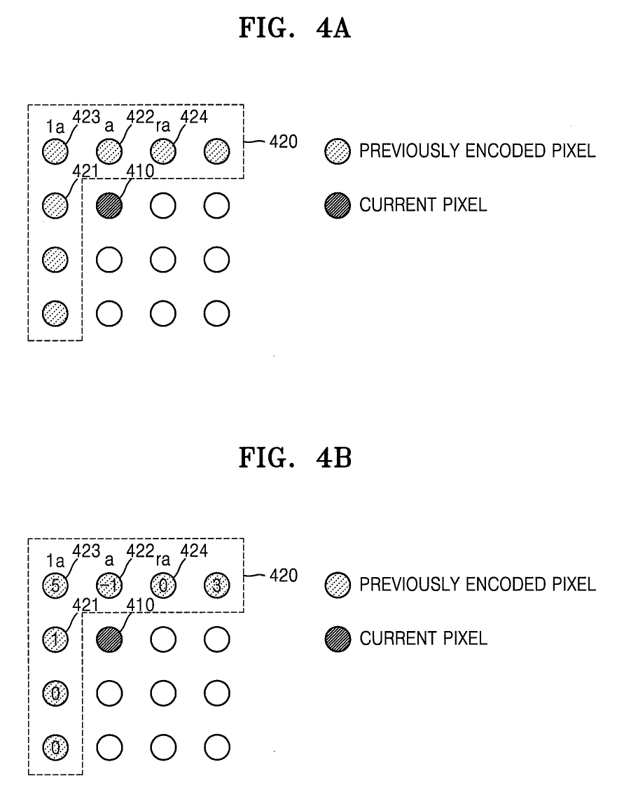

FIGS. 4A and 4B are views for explaining setting of a context model according to an exemplary embodiment of the present invention. In FIGS. 4A and 4B, the selection unit 320 selects a context model to be used for entropy-coding a current pixel 410 by referring to previously encoded pixels 420 that are adjacent to the current pixel 410.

In FIG. 4A, the previously encoded pixels 420 that are adjacent to the current pixel 410 may be included in a block that is different from a block that includes the current pixel 410, or may be included in a same block that includes the current pixel 410 and may have already been encoded.

Although there is no limitation to a method of referring to the adjacent pixels 420, the context model for the current pixel 410 may be selected by determining whether pixel values of the adjacent pixels 420 exist.

Since a context model is determined by a context index indicating a context, the present invention suggests a new context index for a pixel-based context model. Hereinafter, setting of a context index will be described in detail with reference to Equations 1, 2, and 3. However, it can be easily understood by those of ordinary skill in the art that setting of a context index using Equations 1, 2, and 3 is only an example and any method of setting a context index by referring to the adjacent pixels 420 is included in the scope of the present invention.

uiCTX=(1!=0)+(a!=0)<<1 (1)

When a context index is ‘uiCTX’, it is set according to whether a pixel value ‘1’ of a pixel 421 located to the left of the current pixel 410 exists, and whether a pixel value ‘a’ of a pixel 422 located above the current pixel 410 exists. If the pixel value ‘1’ exists, (1!=0) is ‘1’. If not, (1!=0) is ‘0’. If the pixel value ‘a’ exists, (a!=0) is ‘1’. If not, (a!=0) is ‘0’. A symbol ‘<<’ indicates bit shift, and thus ‘binary value<<1’ is a value that is obtained by shifting the binary value by one bit. In other words, ‘1<<1’ is a binary value ‘10’ and a decimal value ‘2’. Thus, if (a!=0) is ‘1’, (a!=0)<<1 is a decimal value ‘2’. If (a!=0) is ‘0’, (a!=0)<<1 is ‘0’.

uiCTX=(1!=0)+(a!=0)<<1+(1a!=0)<<2 (2)

Unlike in Equation 1, in Equation 2, the context index is set by also referring to whether a pixel value of a pixel 423 located to the upper left of the current pixel 410 exists. ‘binary value<<2’ means 2-bit shift. Thus, ‘1<<2’ is a binary value ‘100’ and a decimal value ‘4’. If (1a!=0) is ‘1’, (1a!=0)<<2 is a decimal value ‘4’.

uiCTX=(1!=0)+(a!=0)<<1+(ra!=0)<<2 (3)

Unlike in Equation 3, in Equation 2, the context index is set by referring to a pixel 424 located to the upper right of the current pixel 410 instead of the pixel 423.

FIG. 4B illustrates an example of selection of a context model using FIG. 4A and Equations 1, 2, and 3. In particular, in FIG. 4B, a context index indicating a context model to be used for entropy-coding the current pixel 410 is set with reference to previously encoded pixels 420 that are adjacent to the current pixel 410.

It is assumed that a pixel value of a pixel 421 located to the left of the current pixel is ‘1’, a pixel value of a pixel 422 located above the current pixel is ‘−1’, a pixel value of a pixel 423 located to the upper left of the current pixel is ‘5’, and a pixel value of a pixel 424 located to the upper right of the current picture is ‘0’.

Thus, (1!=0), (a!=0), and (1a!=0) are all ‘1’, and only (ra!=0) is ‘0’.

A context index is calculated as 1+(1<<1)=3 using Equation 1, is calculated as 1+(1<<1)+(1<<2)=7 using Equation 2, and is calculated as 1+(1<<1)+(0<<2)=3 using Equation 3.

Different context models, i.e., probabilities of generation of a binary signal, are assigned to context indices. A coding side sets a context model by referring to previously encoded pixels that are adjacent to the current pixel and performs entropy-coding, i.e., CABAC, on the current pixel using the set context model.

Upon receipt of the entropy-coded pixel, a decoding side calculates a context index by referring to previously decoded pixels that are adjacent to a current pixel and performs CABAC decoding on the current pixel using a context model corresponding to the calculated context index.

Referring back to FIG. 3, the encoding unit 330 performs entropy-coding, i.e., CABAC, on the current pixel using a context model that is selected by the selection unit 320 with reference to previously encoded pixels that are adjacent to the current pixel.

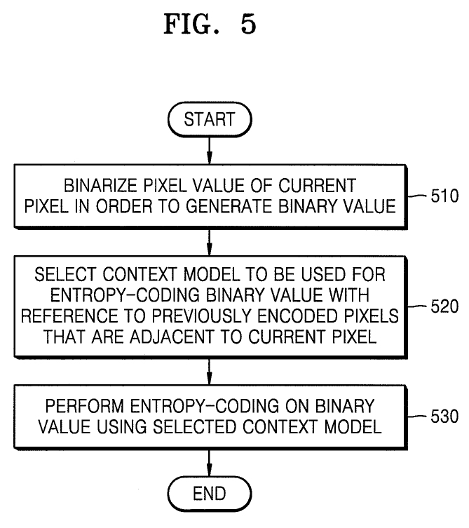

FIG. 5 is a flowchart of a method of encoding an image according to an exemplary embodiment of the present invention.

In operation 510, the apparatus for encoding an image according to the exemplary embodiment of the present invention, as shown in FIG. 3, receives data regarding a current pixel and binarizes the received data, thereby generating a binary value of a pixel value of the current pixel. More specifically, the apparatus receives a pixel value of a quantized current pixel and binarizes the pixel value into a binary value.

Preferably, but not necessarily, a quantized residue that is generated by bypass mode coding is binarized in order to generate a binary value.

In operation 520, the apparatus selects a context model to be used for entropy-coding the binary value generated in operation in 510 by referring to previously encoded pixels that are adjacent to the current pixel. By setting a context index according to whether or not pixel values of pixels that are adjacent to the current pixel exist, a context model to be used for entropy-coding the current pixel is selected.

In operation 530, the apparatus performs entropy-coding on the binary value generated in operation 510 using the context model selected in operation 520. More specifically, the apparatus selects a context model corresponding to the context index that is set in operation 520 with reference to the adjacent pixels and performs CABAC on the binary value using the selected context model.

FIG. 5 is a block diagram of an apparatus 600 for decoding an image according to an exemplary embodiment of the present invention.

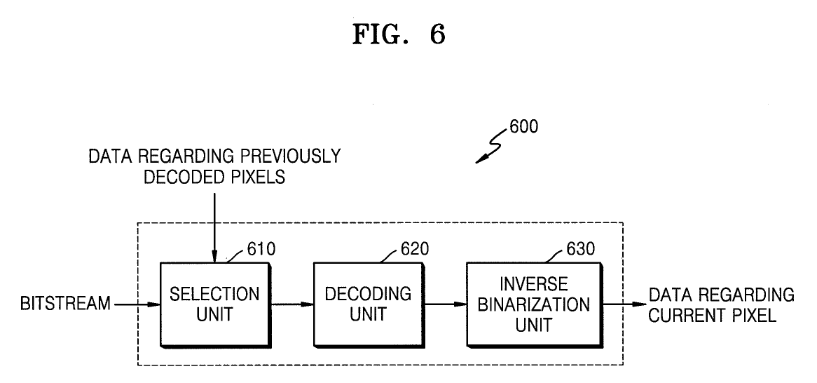

Referring to FIG. 6, the apparatus 600 includes a selection unit 610, a decoding unit 620, and an inverse binarization unit 630.

The selection unit 610 selects a context model to be used for entropy-decoding a current pixel by referring to previously decoded pixels that are adjacent to the current pixel.

More specifically, the selection unit 610 selects a context model by determining whether pixel values of previously decoded pixels exist. Preferably, but not necessarily, the pixel values of the previously decoded pixels are residues for the pixels.

To this end, the selection unit 610 sets a context index by referring to the adjacent pixels, and selects a context model corresponding to the set context index as a context model to be used for entropy-decoding the current pixel.

When a context model is selected by referring to at least one of adjacent pixels located to the left of, to the upper left of, and above, and to the upper right of the current pixel for entropy-coding as illustrated in FIGS. 4A and 4B, a context model is selected by determining whether a pixel value of at least one of adjacent pixels located to the left of, to the upper left of, and above, and to the upper right of the current pixel exists for entropy-decoding.

The decoding unit 620 performs entropy-decoding on data regarding the current pixel using the selected context model. Preferably, but not necessarily, the decoding unit 620 performs context-based adaptive binary arithmetic decoding (CABAD) on a binary value of a pixel value of the current pixel.

The inverse binarization unit 630 performs inverse binarization on the binary value of the entropy-decoded pixel value, thereby reconstructing the pixel value of the current pixel. If the pixel value of the current pixel has been bypass-mode coded, the original pixel value can be reconstructed by inversely quantizing the pixel value that is reconstructed by the inverse binarization unit 630.

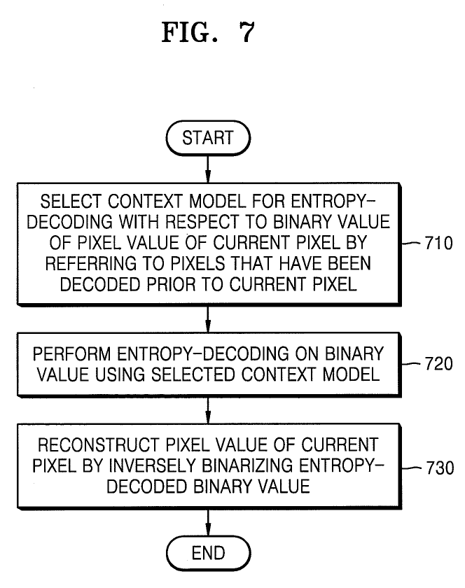

FIG. 7 is a flowchart of a method of decoding an image according to an exemplary embodiment of the present invention.

Referring to FIG. 7, in operation 710, the apparatus 600 selects a context model to be used for entropy-decoding a binary value of a pixel value of a current pixel by referring to previously decoded pixels that are adjacent to the current pixel.

More specifically, the apparatus 600 sets a context index by determining whether pixel values of previously decoded pixels exist and selects a context model corresponding to the set context index as a context model to be used for entropy-coding the current pixel.

In operation 720, the apparatus 600 performs entropy-decoding on a binary value of a pixel value of the current pixel using the context model selected in operation 710. Preferably, but not necessarily, the apparatus 600 performs CABAD on the binary value of the pixel value of the current pixel using the context model selected in operation 710.

In operation 730, the apparatus 600 performs inverse binarization on the binary value of the pixel value that is entropy-decoded, i.e., CABAD-performed in operation 720, thereby reconstructing the pixel value of the current pixel.

As described above, according to the exemplary embodiments of the present invention, a context model is selected for each pixel and entropy-coding/decoding is performed using the selected context model, thereby efficiently performing entropy-coding while reducing the complexity of an apparatus for encoding/decoding an image.

In particular, a context model is selected for each pixel irrespective of a scanning order and a scanning type, thereby preventing inefficient entropy-coding that may occur when the current block is bypass-mode coded in a fixed scanning order.

The exemplary embodiments of the present invention can be embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, and optical data storage devices. The computer-readable recording medium can also be distributed over network of coupled computer systems so that the computer-readable code is stored and executed in a decentralized fashion.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A method of encoding an image, the method comprising:
binarizing a pixel value of a current pixel, thereby generating a binary value;
selecting a context model to be used for entropy-coding the binary value by referring to previously encoded pixels that are adjacent to the current pixel; and
entropy-coding the binary value using the selected context model.

2. The method of claim 1, wherein the pixel value of the current pixel is a residue of the current pixel, which is generated in a bypass mode, and
wherein in the bypass mode, the current pixel comprises a quantized coefficient that is not discrete cosine transformed.

3. The method of claim 1, wherein the selection of the context model comprises:
determining whether pixel values of the previously encoded pixels that are adjacent to the current pixel exist; and
selecting the context model based on a result of the determining.

4. The method of claim 3, wherein the adjacent pixels comprise at least one of adjacent pixels located to left of, to upper left of, above, and to upper right of the current pixel.

5. The method of claim 1, wherein the entropy-coding the binary value comprises performing context-based adaptive binary arithmetic coding (CABAC) on the binary value.

6. The method of claim 1, wherein the contex model is a probability that a binary signal is generated in the binary value.

7. An apparatus for encoding an image, the apparatus comprising:
a binarization unit that binarizes a pixel value of a current pixel, thereby generating a binary value;
a selection unit that selects a context model to be used for entropy-coding the binary value by referring to previously encoded pixels that are adjacent to the current pixel; and
a coding unit that performs entropy-coding on the binary value using the selected context model.

8. The apparatus of claim 7, wherein the pixel value of the current pixel is a residue of the current pixel, which is generated in a bypass mode, and
wherein in the bypass mode, the current pixel comprises a quantized coefficient that is not discrete cosine transformed.

9. The apparatus of claim 7, wherein the selection unit determines whether pixel values of the previously encoded pixels that are adjacent to the current pixel exist, and selects the context model based on a result of the determination.

10. The apparatus of claim 9, wherein the adjacent pixels comprise at least one of adjacent pixels located to left of, to upper left of, above, and to upper right of the current pixel.

11. The apparatus of claim 7, wherein the coding unit performs context-based adaptive binary arithmetic coding (CABAC) on the binary value.

12. A method of decoding an image, the method comprising:
selecting a context model to be used for entropy-decoding a binary value of a pixel value of a current pixel by referring to previously decoded pixels that are adjacent to the current pixel;
entropy-decoding the binary value using the selected context model; and
performing inverse binarization on the entropy-decoded binary value, thereby reconstructing the pixel value of the current pixel.

13. The method of claim 12, wherein the pixel value of the current pixel is a residue of the current pixel, which is generated in a bypass mode, and
wherein in the bypass mode, the current pixel comprises a quantized coefficient that is not discrete cosine transformed.

14. The method of claim 12, wherein the selection of the context model comprises:
determining whether pixel values of the previously decoded pixels that are adjacent to the current pixel exist; and
selecting the context model based on a result of the determining.

15. The method of claim 14, wherein the adjacent pixels comprise at least one of adjacent pixels located to left of, to upper left of, above, and to upper right of the current pixel.

16. The method of claim 12, wherein the entropy-decoding of the binary value comprises performing context-based adaptive binary arithmetic decoding (CABAD) on the binary value.

17. The method of claim 12, wherein the contex model is a probability that a binary signal is generated in the binary value.

18. An apparatus for decoding an image, the apparatus comprising:
a selection unit that selects a context model to be used for entropy-decoding a binary value of a pixel value of a current pixel by referring to previously decoded pixels that are adjacent to the current pixel;
a decoding unit that performs entropy-decoding on the binary value using the selected context model; and
an inverse binarization unit that performs inverse binarization on the entropy-decoded binary value, thereby reconstructing the pixel value of the current pixel.

19. The apparatus of claim 18, wherein pixel value of the current pixel is a residue of the current pixel, which is generated in a bypass mode, and
wherein in the bypass mode, the current pixel comprises a quantized coefficient that is not discrete cosine transformed.

20. The apparatus of claim 18, wherein the selection units determines whether pixel values of the previously decoded pixels that are adjacent to the current pixel exist, and selects the context model based on a result of the determination.

21. The apparatus of claim 20, wherein the adjacent pixels comprise at least one of adjacent pixels located to left of, to upper left of, above, and to upper right of the current pixel.

22. The apparatus of claim 18, wherein the decoding unit performs context-based adaptive binary arithmetic decoding (CABAD) on the binary value.

23. A computer-readable recording medium having recorded thereon a program for executing the method of claim 1.

24. A computer-readable recording medium having recorded thereon a program for executing the method of claim 11.
